(19) United States
(12) Patent Application Publication
(10) Pub. No.: US 2016/0236021 A1
(43) Pub. Date: Aug. 18, 2016

(54) Extended Height Overlapping Nozzle Protection

(71) Applicant: Tyco Fire Products LP, Lansdale, PA (US)

(72) Inventors: Joshua L. Ehlers, Marinette, WI (US); William G. White, Traverse City, MI (US)

(21) Appl. No.: 15/047,571

(22) Filed: Feb. 18, 2016

Related U.S. Application Data
(60) Provisional application No. 62/117,933, filed on Feb. 18, 2015.

(51) Int. Cl. A62C 3/00; A62C 35/02

(52) U.S. Cl. CPC A62C 3/006; A62C 35/02

(57) ABSTRACT

Fire protection system and methods for a cooking appliance located in a hazard zone includes a firefighting supply and one or more nozzles coupled to the supply for generating a spray pattern to address a fire in the hazard zone. The system includes a preferred nozzle location zone to locate the nozzle outlet at a nozzle height from the hazard zone. The nozzle location zone has a first linear edge and a second linear edge spaced from the first linear edge with each of the first and second linear edges being parallel to the hazard zone. The second linear edge defines a minimum nozzle height and the first linear edge defines a maximum nozzle height. The maximum nozzle height ranges from sixty inches (60 in.) to sixty-eight inches (68 in.) from the hazard.

### PRIORITY DATA & INCORPORATION BY REFERENCE

This application claims the benefit of U.S. Provisional Application No. 62/117,933, “Extended Height Overlapping Nozzle Protection,” filed on Feb. 18, 2015, which is incorporated by reference in its entirety.

### TECHNICAL FIELD

This invention relates to fire protection systems, and more particularly fire suppression systems using nozzles for the protection of kitchens.

### BACKGROUND

Known fire suppression systems for kitchens include nozzles suspended from pipes that extend into the kitchen space including into spaces occupied by kitchen personnel or area subject to grease and other particles. Thus, the suspended nozzles and associated piping can cause one or more of the following problems for maintaining proper operation of both the fire protection and the kitchen functions: (i) being a source of or create a contamination issue or risk; (ii) present a physical obstruction and source of injury for kitchen personnel; (iii) be subject to tampering; (iv) impede work operations within the kitchen; (v) occupy space such that the nozzles and piping can limit the space for cooking appliances. Moreover, the nozzle and associated piping can be aesthetically unpleasant. It is therefore desirable to have a fire suppression systems for kitchens with nozzles suspended at higher heights than currently available in order to minimize, prevent or otherwise eliminate the aforementioned problems.

### SUMMARY OF THE INVENTION

A preferred fire suppression system for fire protection of kitchens is provided. The system includes a nozzle location zone for locating a fire suppression nozzle in a manner that overcomes the problems and disadvantages addressed above. The preferred nozzle location zone provides for nozzle installations at suspended heights greater than previously known. The increased height moves the nozzles out of the kitchen spaces to minimize or more preferably eliminate the risks of contamination, injury and interference to kitchen operations and personnel.

One preferred embodiment of a fire protection system for a cooking appliance located in a hazard zone includes a firefighting supply and one or more nozzles coupled to the supply for generating a spray pattern to address a fire in the hazard zone. The nozzle have an outlet for discharge of a firefighting agent. The system includes a preferred nozzle location zone to locate the nozzle outlet at a nozzle height from the hazard zone. The nozzle location zone has a first linear edge and a second linear edge spaced from the first linear edge with each of the first and second linear edges being parallel to the hazard zone. The second linear edge of the nozzle location zone is closer to the hazard zone than the first linear edge to define a minimum nozzle height and the first linear edge is at a distance ranging from sixty inches (60 in.) to sixty-eight inches (68 in.) from the hazard zone to define a maximum nozzle height.

The preferred systems and nozzle location zones also provide for preferred methods of fire protection for hazard zones that includes supplying a firefighting agent to a nozzle and locating the nozzle in a preferred nozzle location zone defining a maximum nozzle height and a minimum nozzle height. The maximum nozzle height preferably ranging from sixty inches (60 in.) to sixty-eight inches (68 in.) from the hazard zone.

Alternatively or additionally, a preferred method of fire protection of a includes obtaining a fire protection nozzle; and distributing the nozzle for installation in a nozzle location above a hazard zone in which the hazard zone defines a maximum nozzle height and a minimum nozzle height. The maximum nozzle height preferably ranges from sixty inches (60 in.) to sixty-eight inches (68 in.) from the hazard zone.

### DESCRIPTION OF DRAWINGS

The accompanying drawings, which are incorporated herein and constitute part of this specification, illustrate exemplary embodiments of the invention and, together with the general description given above and the detailed description given below, serve to explain the features of the exemplary embodiments of the invention.

FIG. 1 is a schematic elevation view of a preferred kitchen suppression system; and

FIG. 2 is a partial schematic plan view of the system of FIG. 1.

Like reference symbols in the various drawings indicate like elements.

### DETAILED DESCRIPTION

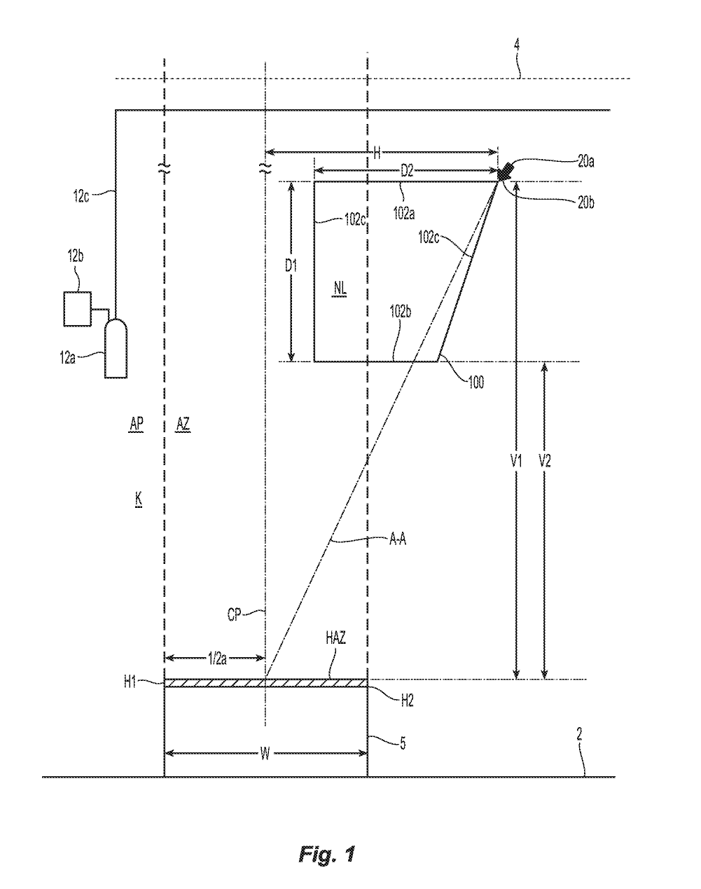

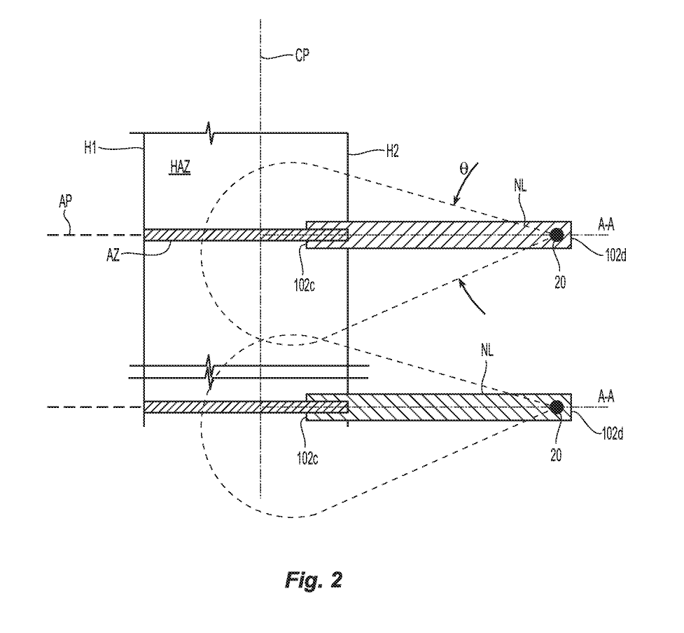

Shown in FIGS. 1 is a schematic illustration of kitchen K having a floor 2, a ceiling 4 at a vertical distance above the floor 2 with a defined hazard zone HAZ defined above a volume 5. As used herein, a “hazard zone” is a theoretical rectangular plane, as shown in plan in FIG. 1 and FIG. 2, disposed parallel to the floor that includes all the cooking hazards of the appliances to be protected by a fire protection system. The hazard zone HAZ defines the area for location of kitchen appliances and the area to be targeted preferably by overlapping nozzle appliance protection. A cooking appliance can completely fill the hazard zone HAZ or a portion thereof. For the purposes herein, “overlapping nozzle appliance protection” is the protection of cooking appliances by nozzles spaced uniformly at uniform elevations.

FIG. 1 which shows a cross-section of the hazard zone HAZ in an axial plane AP. The hazard zone has a first edge H1 and a second edge H2 spaced from the first edge H1 to define a hazard zone depth or width W in which a cooking hazard of a protected appliance is located. The hazard zone width W can range from 28 inches to 36 inches and can be any one of 30 inches and 34 inches. The hazard zone depth W has a midpoint between the first and second edge H1, H2. The hazard zone HAZ defines a vertical projection AZ of the hazard zone into the axial plane AP between the first and second edges H1, H2 of the hazard zone. A central plane CP extends perpendicular to the hazard zone HAZ and axial plane AP and extends through the midpoint of the hazard zone depth W parallel to each of the first and second edges H1, H2 so as to bisect the hazard zone HAZ and the vertical projection AZ of the hazard zone.

A preferred fire protection system 10 for an appliance(s) located within the hazard zone HAZ is shown. The preferred system 10 includes a firefighting supply 12 preferably having a tank of firefighting agent or preferred suppressant 12a and a releasing assembly or mechanism 32. A distribution network of piping 12c connects the agent 12a to one and preferably more than one fire protection nozzle 20 to define the preferred overlapping nozzle appliance protection in the hazard zone. The releasing assembly or mechanism 32 is arranged with the supply 30 to control the release and delivery of the firefighting agent 30 to the nozzle 20 for effectively addressing a fire. The releasing assembly 32 can be electrically or mechanically controlled and can include automatic or manual actuating devices and associated fire detection equipment that can be mechanically linked or electrically interconnected by hard wired or wireless connections. The nozzle 20 is a device having an inlet 20a for receipt of the released agent or other firefighting fluid and an outlet 20b for spraying the agent over a distance to define the preferred spray pattern for addressing and more preferably suppressing the fire in the hazard zone HAZ.

The preferred system includes a nozzle location zone NL or region in which the outlet 20b of a nozzle 20 can be located above the hazard zone HAZ at which an effective spray pattern for addressing a fire can be generated. The nozzle location zone NL locates the one or more nozzle(s) 20 and more particularly its outlet 20b to defines a nozzle height from the hazard zone HAZ. In the preferred embodiments, the nozzle location zone HAZ locates a nozzle outlet 20b at increased heights above the hazard zone HAZ not previously achieved thereby eliminating the risk of contamination, injury and interference with kitchen personnel. As seen in FIG. 1, the nozzle location zone NL is preferably defined by a plurality of linear edges 102. In preferred embodiments, the so as to more preferably define a polygon. Additionally or alternatively, the preferred geometric boundary can be defined by a number of linear edges to approximate a closed form having one or more arcuate edges such as, for example, a circle, ellipse or oval or any other closed form shape.

The plurality of linear edges 102 preferably include a first linear edge 102a and a second linear edge 102b each extending parallel to the hazard zone HAZ. The first linear edge 102a is the most remote or furthest from the hazard zone HAZ and the second linear edge 102b is the most proximate or closest to the hazard zone HAZ. Accordingly, the first linear edge 102a defines a maximum nozzle height V1 and the second linear edge 102b defines a minimum nozzle height V2 above the hazard zone. In a preferred embodiment, the first linear edge 102a is preferably disposed at a maximum distance from hazard zone HAZ to define a preferred maximum nozzle height V1 that ranges from about 60 inches to about 68 inches (60-68 in.). In a preferred embodiment, the maximum nozzle height is sixty-eight inches (68 in.) and in an alternate embodiment, is sixty inches (60 in.). The second linear edge 102b is preferably disposed at a minimum distance from the hazard zone HAZ to define a minimum nozzle height that that is preferably over fifty inches (50 in.) and more preferably ranges from fifty-four to sixty inches (54 in.-60 in.). For the preferred overlapping nozzle appliance protection, the plurality of nozzles 20 are located and oriented with their outlets 20b in the preferred nozzle location zone NL at common or same height above the hazard zone HAZ preferably at a maximum nozzle height and more preferably at least sixty-eight inches above the hazard zone HAZ. Moreover, the plurality of nozzles 20 are preferably spaced apart along the length of the hazard zone HAZ to provide the preferred overlapping protection.

The nozzle location zone NL locates the outlet relative to the hazard zone. Moreover the nozzle location NL defines a nozzle axis A-A between a nozzle outlet 20b and a preferred target of the hazard zone HAZ. For example, a preferred target is at the intersection between the hazard zone and a central plane bisecting the hazard zone along its length. The nozzle 20 is preferably oriented at its nozzle height within the nozzle location zone such that the outlet is directed along the preferred nozzle axis A-A and aimed at the preferred target. Alternate targets in the hazard zone HAZ can be identified to alternatively orient the nozzle 20.

With the one or more nozzles 20 located and oriented within the preferred nozzle location zone NL, the nozzle 20 in an actuated state of the system 10 generates a preferred spray pattern, preferably a conical spray pattern, about the nozzle axis A-A. A preferred spray pattern effectively addresses and more preferably suppresses a fire. Exemplary characteristics of a preferred spray pattern from a located nozzle 20 can be one or more combinations of spray angle about the axis A-A, a droplet size, a droplet velocity, a spray profile, and/or density over the hazard zone HAZ. Thus, factors affecting or defining the preferred spray pattern can be any one of working nozzle flow rates and/or fluid delivery pressure or working pressure of the nozzle at its nozzle height within the nozzle location zone NL. Accordingly, there are one or more preferred relationships between the firefighting supply 12 and the preferred nozzle location zone NL. With reference to FIG. 2 and the located nozzle 20, a preferred spray angle θ about a nozzle axis A-A ranges from 29°-46° degrees and more preferably range 29°-39° degrees and 36°-46° degree. Alternatively or additionally, a preferred working pressures and/or flow rates to the nozzle 20 and its outlet 20b at its preferred nozzle height are, for example, a working flow rate of 1.5-2 gallons per minute (gpm) and more preferably ranging 1.7-1.75 gpm and/or a working pressure of 30-140 psi and more preferably 80 psi.

For the preferred nozzle location zone NL and maximum nozzle height ranging from sixty inches to sixty-eight inches, there is a preferred relationship with the firefighting supply 12 to provide for the effective spray pattern at the increased heights. For example, the nozzle location zone NL and supply 12 define a preferred ratio of outlet maximum nozzle height-to-working fluid pressure that ranges from 2.3:1 to 0.5:1. Alternatively or additionally, the nozzle location zone NL and supply 12 defining a preferred ratio of maximum nozzle height-to-working flow rate from the nozzle that ranges from 45:1 to 34:1.

The nozzle location zone NL additionally or alternatively preferably defines a closed formed boundary in which to locate and orient a nozzle 20. The first linear edge 102a and a second linear edge 102b are spaced apart from one another to define a vertical length D1 of the nozzle location zone NL parallel to the central plane CP. The plurality of linear edges 102 further preferably includes a third linear edge 102c and at least a fourth linear edge 102d spaced apart from one another to define a horizontal width D2 of the nozzle location zone NL parallel to the hazard zone HAZ.

In one preferred embodiment of the nozzle location zone NL, the nozzle location zone NL is spaced or off-set from the central plane CP in the axial plane AP. The third linear edge 102c is the most proximate or closest to the hazard zone central plane CP and the fourth linear edge 102b is the most remote or furthest from the central plane CP. The third linear edge 102c is preferably parallel to the central plane CP and in one embodiment, the fourth linear edge is skewed with respect to the central plane CP. In one preferred aspect a nozzle location zone NZ is substantially trapezoidal as shown.

A number of embodiments of the invention have been described. Nevertheless, it will be understood that various modifications may be made without departing from the spirit and scope of the invention. Accordingly, it is intended that the present invention not be limited to the described embodiments, but that it has the full scope defined by the language of the following claims, and equivalents thereof.

What is claimed is:

1. A fire protection system for a cooking appliance within a hazard zone, the system comprising:
a firefighting supply;
at least one nozzle coupled to the supply for generating a spray pattern to address a fire in the hazard zone, the at least one nozzle having an outlet; and
a nozzle location zone to locate the nozzle outlet at a nozzle height above the hazard zone, the nozzle location zone having a first linear edge and a second linear edge spaced from the first linear edge, each of the first and second linear edges being parallel to the hazard zone with the second linear edge being closer to the hazard zone than the first linear edge to define a minimum nozzle height, the first linear edge being at a distance ranging from sixty inches (60 in.) to sixty-eight inches (68 in.) from the hazard zone to define a maximum nozzle height.

2. The system of claim 1, wherein the supply provides a working pressure to the at least one nozzle in the nozzle location zone, the nozzle location zone and supply defining a ratio of outlet maximum height-to-working fluid pressure that ranges from 2.3:1 to 0.5:1.

3. The system of claim 1, wherein the supply provides a working flow rate to the at least one nozzle in the nozzle location zone, the nozzle location zone and supply defining a ratio of outlet maximum height-to-working flow rate from the nozzle that ranges from 45:1 to 34:1.

4. The system of claim 1, wherein the supply includes a tank of firefighting agent and a piping arrangement to couple the tank to the at least one nozzle, the supply tank and piping defining at least one of: (i) a working flow rate of about 1.5-2 gallons per minute (gpm) at the at least one nozzle in the nozzle location zone; and (ii) a working fluid pressure between 30-140 psi at the at least one nozzle in the nozzle location zone.

5. The system of claim 1, wherein the nozzle location zone defines a nozzle axis along which the nozzle outlet is directed, the nozzle axis being aimed at a target in the hazard zone to define a conical spray pattern from the at least one nozzle having a spray angle about the nozzle axis that ranges between 29°-46° degrees within the nozzle location zone.

6. The system of claim 5, wherein the spray angle ranges between one of 29°-39° degrees and 36°-46° degrees.

7. The system of claim 5, wherein the target is defined by an intersection of the hazard zone and a central plane bisecting the hazard zone along its length.

8. The system of claim 1, wherein the maximum nozzle height is sixty inches (60 in.) above the hazard zone.

9. The system of claim 1, wherein the maximum nozzle height is sixty-eight inches (68 in.) above the hazard zone.

10. The system of claim 1, wherein the minimum nozzle height is over fifty inches (50 in.) above the hazard zone.

11. The system of claim 10, wherein the minimum nozzle height is fifty-four inches (54 in.) above the hazard zone.

12. The system of claim 1, wherein the minimum nozzle height is 60 inches above the hazard zone.

13. The system of claim 1, wherein the nozzle location zone includes a third linear edge extending between and perpendicular to each of the first and second linear edges, the third linear edge spaced from a central plane bisecting and perpendicular to the hazard zone along its length.

14. The system of claim 13, wherein the nozzle location zone includes at least a fourth linear edge extending between the first and second linear edges and spaced further from the central plane than the third linear edge, the fourth linear edge being skewed with respect to the third linear edge.

15. The system of claim 1, wherein the at least one nozzle includes a plurality of nozzles with their outlets in the nozzle location zone at the same height above the hazard zone at least sixty-eight inches above the hazard zone.

16. The system of claim 15, wherein the plurality of nozzles are evenly spaced apart along the length of the hazard zone to provide overlapping protection.
